(19) United States
(12) Patent Application Publication
(10) Pub. No.: US 2015/0180118 A1
(43) Pub. Date: Jun. 25, 2015

(54) ANTENNA SYSTEM WITH HIGH ISOLATION CHARACTERISTICS

(71) Applicant: Wistron NeWeb Corp., Hsinchu (TW)

(72) Inventors: Yu-Tsung HUANG, Hsinchu (TW); Cheng-Da YANG, Hsinchu (TW)

(21) Appl. No.: 14/339,996

(22) Filed: Jul. 24, 2014

(30) Foreign Application Priority Data
Dec. 23, 2013 (TW) 102147704

(51) Int. Cl. H01Q 1/52

(52) U.S. Cl. CPC H01Q 1/526; H01Q 1/521

(57) ABSTRACT

An antenna system includes at least one antenna element. The antenna element includes a ground plane, a grounding isolation element, and a feeding element. The grounding isolation element has a bending structure. A grounding end of the grounding isolation element is coupled to an edge of the ground plane. A feeding end of the feeding element is coupled to a signal source, and an open end of the feeding element is adjacent to an open end of the grounding isolation element, such that a resonant path is formed by the feeding element and the grounding isolation element. The grounding isolation element is configured to reduce radiation of the antenna element in a specific direction.

### CROSS REFERENCE TO RELATED APPLICATIONS

This Application claims priority of Taiwan Patent Application No. 102147704 filed on Dec. 23, 2013, the entirety of which is incorporated by reference herein.

### BACKGROUND OF THE INVENTION

1. Field of the Invention

The disclosure generally relates to an antenna system, and more particularly to an antenna system with high isolation characteristics.

1. Description of the Related Art

With the progress of mobile communication technology, portable electronic devices, such as portable computers, mobile phones, tablet computers, multimedia players, and other hybrid functional mobile devices, have become more common. To satisfy consumer demand, portable electronic devices can usually perform wireless communication functions. Some functions cover a large wireless communication area; for example, mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some functions cover a small wireless communication area; for example, mobile phones using Wi-Fi, Bluetooth, and WiMAX (Worldwide Interoperability for Microwave Access) systems and using frequency bands of 2.4 GHz, 3.5 GHz, 5.2 GHz, and 5.8 GHz.

Antennas are indispensable elements for wireless communication in mobile devices. In conventional designs, multiple antennas are often incorporated into a mobile device and are arranged to receive and transmit-signals. However, if these antennas have an identical or similar operation frequency, they may tend to interfere with each other, and the serious mutual coupling between these antennas may further degrade the communication quality of the mobile device.

### BRIEF SUMMARY OF THE INVENTION

To overcome the drawbacks of the prior art, in one exemplary embodiment, the disclosure is directed to an antenna system including a first antenna element. The first antenna element includes a first ground plane, a first grounding isolation element, and a first feeding element. The first grounding isolation element has a bending structure. A grounding end of the first grounding isolation element is coupled to a first edge of the first ground plane. A feeding end of the first feeding element is coupled to a first signal source, and an open end of the first feeding element is adjacent to an open end of the first grounding isolation element, such that a first resonant path is formed by the first feeding element and the first grounding isolation element. The first grounding isolation element is configured to reduce the radiation of the first antenna element in a first direction.

### BRIEF DESCRIPTION OF DRAWINGS

The invention can be more fully understood by reading the subsequent detailed description and examples with references made to the accompanying drawings, wherein:

FIG. 1 shows a diagram of an antenna system according to an embodiment of the invention;

FIG. 2 shows a diagram of an antenna system according to an embodiment of the invention;

FIG. 3A shows a radiation pattern of a first antenna element on a coordinate plane according to an embodiment of the invention;

FIG. 3B shows a radiation pattern of a second antenna element on a coordinate plane according to an embodiment of the invention;

FIG. 4 shows an isolation level between a first antenna element and a second antenna element according to an embodiment of the invention;

FIG. 5 shows a diagram of a first antenna element according to an embodiment of the invention;

FIG. 6 shows a diagram of a first antenna element according to an embodiment of the invention; and

FIG. 7 shows a diagram of a first antenna element according to an embodiment of the invention.

### DETAILED DESCRIPTION OF THE INVENTION

In order to illustrate the purposes, features and advantages of the invention, the embodiments and figures of the invention are shown in detail as follows.

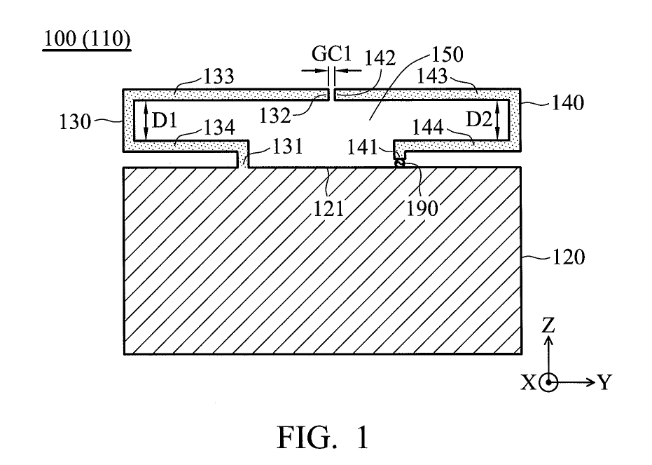

FIG. 1 shows a diagram of an antenna system 100 according to an embodiment of the invention. The antenna system 100 may be applied to a mobile device, such as a smart phone, a tablet computer, or a notebook computer. As shown in FIG. 1, the antenna system 100 includes at least a first antenna element 110. The first antenna element 110 may be made of metal and disposed on a dielectric substrate, such as an FR4 (Flame Retardant 4) substrate. The first antenna element 110 includes a first ground plane 120, a first grounding isolation element 130, and a first feeding element 140. The first ground plane 120 has a first edge 121. The first grounding isolation element 130 has a bending structure. One end of the first grounding isolation element 130 is a grounding end 131 which is coupled to the first edge 121 of the first ground plane 120, and another end of the first grounding isolation element 130 is an open end 132. The first feeding element 140 may also have a bending structure. One end of the first feeding element 140 is a feeding end 141 which is coupled to a first signal source 190. The first signal source 190 may be an RF (Radio Frequency) module for exciting the first antenna element 110. Another end of the first feeding element 140 is an open end 142 which is adjacent to the open end 132 of the first grounding isolation element 130, such that a first resonant path is formed by the first feeding element 140 and the first grounding isolation element 130. When the first antenna element 110 is fed from the first signal source 190, the first resonant path (including the first feeding element 140 and the first grounding isolation element 130) is excited to generate a low frequency band, and the first feeding element 140 is excited to generate a high frequency band. In some embodiments, the low frequency band is substantially from 2200 MHz to 2800 MHz, and the high frequency band is substantially from 4920 MHz to 5850 MHz.

In some embodiments, a first coupling gap GC1 is formed between the open end 142 of the first feeding element 140 and the open end 132 of the first grounding isolation element 130, and the width of the first coupling gap GC1 is at least 0.1 mm. In other embodiments, the width of the first coupling gap GC1 is from about 0.1 mm to about 10 mm. The first coupling gap GC1 is used to adjust the operation bandwidth of the first antenna element 110. For example, if the width of the first coupling gap GC1 is increased, the operation bandwidth of the first antenna element 110 will be increased accordingly, and if the width of the first coupling gap GC1 is decreased, the operation bandwidth of the first antenna element 110 will be decreased accordingly. In some embodiments, a clearance region 150 is formed and substantially surrounded by the first feeding element 140, the first grounding isolation element 130, and the first edge 121 of the first ground plane 120. In some embodiments, the first grounding isolation element 130 substantially has a U-shape. More particularly, the first grounding isolation element 130 includes a first branch 133 and a second branch 134. The first branch 133 is adjacent to the open end 132 of the first grounding isolation element 130, and the second branch 134 is adjacent to the grounding end 131 of the first grounding isolation element 130. The first branch 133 and the second branch 134 are both substantially parallel to the first edge 121 of the first ground plane 120. The spacing D1 between the first branch 133 and the second branch 134 should be at least 0.2 mm. In some embodiments, the first feeding element 140 also substantially has a U-shape. More particularly, the first feeding element 140 includes a first branch 143 and a second branch 144. The first branch 143 is adjacent to the open end 142 of the first feeding element 140, and the second branch 144 is adjacent to the feeding end 141 of the first feeding element 140. The first branch 143 and the second branch 144 are both substantially parallel to the first edge 121 of the first ground plane 120. The spacing D2 between the first branch 143 and the second branch 144 should be at least 0.2 mm.

When the first antenna element 110 is fed from the first signal source 190, the first branch 133 and the second branch 134 of the first grounding isolation element 130 are excited to generate surface currents in opposite directions, and it therefore reduces the radiation of the first antenna element 110 in a first direction. In the embodiment of FIG. 1, the first direction is equivalent to the −Y axis direction. In other words, the first grounding isolation element 130 is configured as a combination of a radiation element and an isolation element. The first grounding isolation element 130 can be excited to generate the antenna operation frequency bands, and can also prevent other components disposed in the −Y axis direction from being affected by the radiation of the first antenna element 110.

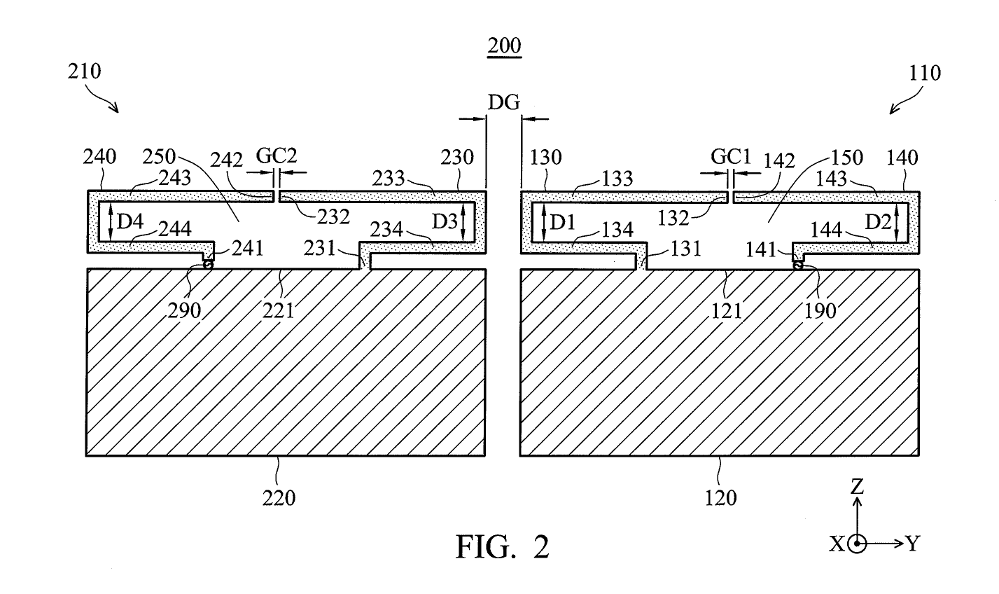

FIG. 2 shows a diagram of an antenna system 200 according to an embodiment of the invention. The antenna system 200 includes a first antenna element 110 and a second antenna element 210. The features of the first antenna element 110 have been described in the embodiment of FIG. 1. The second antenna element 210 may be made of metal and disposed on a dielectric substrate. The second antenna element 210 includes a second ground plane 220, a second grounding isolation element 230, and a second feeding element 240. The second ground plane 220 has a second edge 221. The second grounding isolation element 230 has a bending structure. One end of the second grounding isolation element 230 is a grounding end 231 which is coupled to the second edge 221 of the second ground plane 220, and another end of the second grounding isolation element 230 is an open end 232. One end of the second feeding element 240 is a feeding end 241 which is coupled to a second signal source 290. The second signal source 290 may be an RF module for exciting the second antenna element 210. In some embodiments, the second signal source 290 and the first signal source 190 have the same excitation frequency. Another end of the second feeding element 240 is an open end 242 which is adjacent to the open end 232 of the second grounding isolation element 230, such that a second resonant path is formed by the second feeding element 240 and the second grounding isolation element 230. When the second antenna element 210 is fed from the second signal source 290, the second resonant path (including the second feeding element 240 and the second grounding isolation element 230) is excited to generate a low frequency band, and the second feeding element 240 is excited to generate a high frequency band. In some embodiments, the low frequency band is substantially from 2200 MHz to 2800 MHz, and the high frequency band is substantially from 4920 MHz to 5850 MHz.

In some embodiments, a second coupling gap GC2 is formed between the open end 242 of the second feeding element 240 and the open end 232 of the second grounding isolation element 230, and the width of the second coupling gap GC2 is at least 0.1 mm. In other embodiments, the width of the second coupling gap GC2 is from about 0.1 mm to about 10 mm. In some embodiments, a clearance region 250 is formed and substantially surrounded by the second feeding element 240, the second grounding isolation element 230, and the second edge 221 of the second ground plane 220. In some embodiments, the second grounding isolation element 230 substantially has a U-shape. The second grounding isolation element 230 includes a second branch 233 and a second branch 234. The first branch 233 is adjacent to the open end 232 of the second grounding isolation element 230, and the second branch 234 is adjacent to the grounding end 231 of the second grounding isolation element 230. The first branch 233 and the second branch 234 are both substantially parallel to the second edge 221 of the second ground plane 220. The spacing D3 between the first branch 233 and the second branch 234 should be at least 0.2 mm. In some embodiments, the second feeding element 240 also substantially has a U-shape. The second feeding element 240 includes a first branch 243 and a second branch 244. The first branch 243 is adjacent to the open end 242 of the second feeding element 240, and the second branch 244 is adjacent to the feeding end 241 of the second feeding element 240. The first branch 243 and the second branch 244 are both substantially parallel to the second edge 221 of the second ground plane 220. The spacing D4 between the first branch 243 and the second branch 244 should be at least 0.2 mm.

When the second antenna element 210 is fed from the second signal source 290, the first branch 233 and the second branch 234 of the second grounding isolation element 230 are excited to generate surface currents in opposite directions, and it therefore reduces the radiation of the second antenna element 210 in a second direction. In the embodiment of FIG. 2, the second direction is equivalent to the +Y axis direction. The second grounding isolation element 230 can be excited to generate the antenna operation frequency bands, and can also prevent other components disposed in the +Y axis direction from being affected by the radiation of the second antenna element 210.

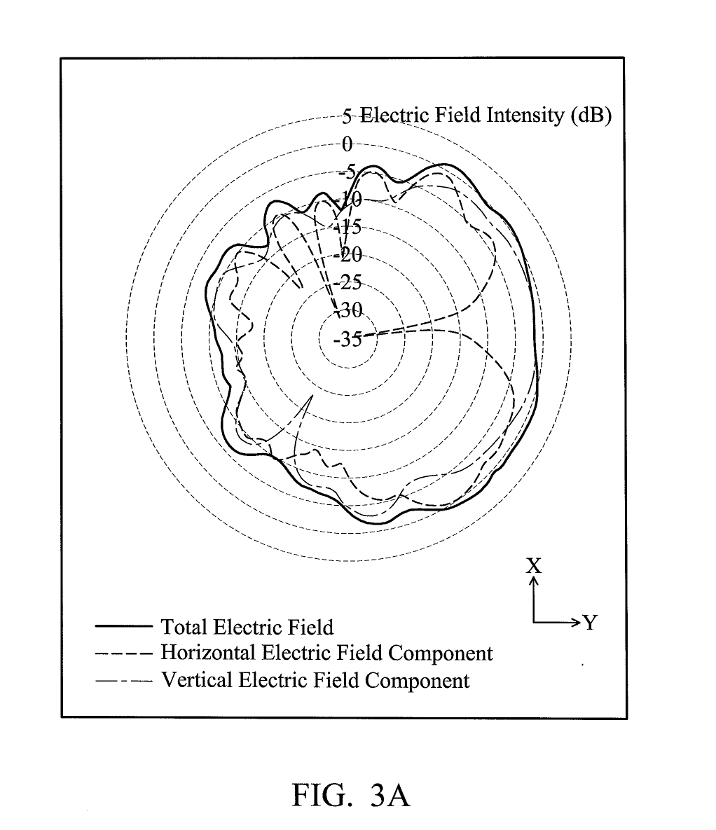

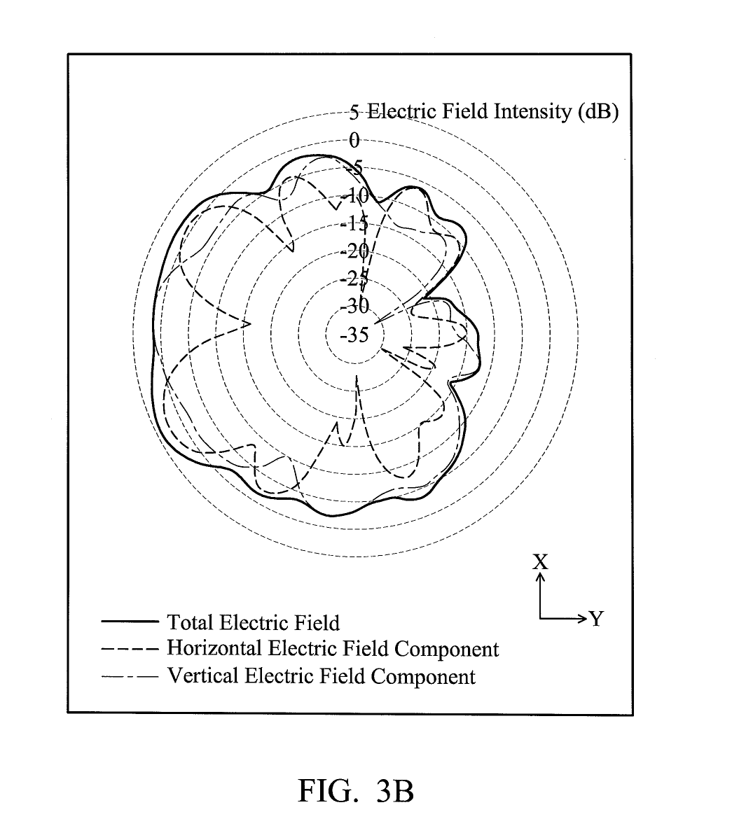

To be brief, in the embodiment of FIG. 2, the second antenna element 210 is substantially equivalent to a left-right mirror image of the first antenna element 110, and the second grounding isolation element 230 of the second antenna element 210 is disposed adjacent to the first grounding isolation element 130 of the first antenna element 110. The spacing DG between the first antenna element 110 and the second antenna element 210 should be at least 1 mm. FIG. 3A shows a radiation pattern of the first antenna element 110 on the XY plane according to an embodiment of the invention. FIG. 3B shows a radiation pattern of the second antenna element 210 on the XY plane according to an embodiment of the invention. Please refer to FIG. 2, FIG. 3A, and FIG. 3B together. When the first antenna element 110 and the second antenna element 210 substantially operate in the same frequency band, the first grounding isolation element 130 can suppress the radiation pattern of the first antenna element 110 in the first direction (−Y axis), and the second grounding isolation element 230 can suppress the radiation pattern of the second antenna element 210 in the second direction (+Y axis). Since the first direction (−Y axis) of the first antenna element 110 is opposite to the second direction (+Y axis) of the second antenna element 210, the first antenna element 110 and the second antenna element 210 do not tend to interfere with each other, and the isolation level of the antenna system 200 is significantly enhanced accordingly. FIG. 4 shows an isolation level (S21) between the first antenna element 110 and the second antenna element 210 according to an embodiment of the invention. According to the measurement result of FIG. 4, the isolation level (S21) between the first antenna element 110 and the second antenna element 210 is lower than −20 dB over the frequency range from 2200 MHz to 5800 MHz, and it meets the requirements of applications of general antenna systems with high isolation characteristics. The antenna element and the antenna system of the invention can effectively solve the interference problem due to mutual coupling between conventional multiple antennas. Furthermore, since the grounding isolation element is also a portion of the resonant path of the antenna element, it does not occupy additional design space. The invention can improve the isolation level of the antenna system without increasing the total size, and the invention is therefore suitable for applications in a variety of small-size mobile devices.

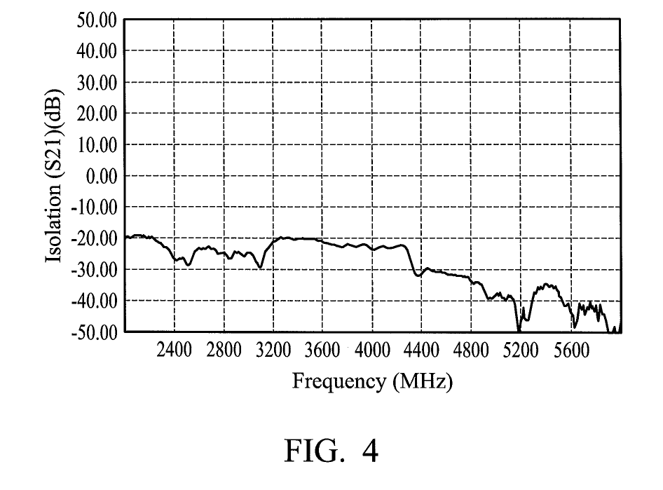

In other embodiments, adjustments are made such that the antenna system has an asymmetrical design, and the antenna elements therein have different structures from those described in the above figures. The antenna system may include more than three antenna elements. The following embodiments of FIGS. 5-7 will describe some adjustments of the invention. It should be understood that these adjustments may be also applied to the second antenna element correspondingly although the figures just display the adjustments of the first antenna element as examples.

FIG. 5 shows a diagram of a first antenna element 510 according to an embodiment of the invention. In the embodiment of FIG. 5, a first grounding isolation element 530 of the first antenna element 510 has a meandering structure. For example, the first grounding isolation element 530 may substantially have a W-shape. Also, for example, the first grounding isolation element 530 may substantially have a combination of one or more U-shapes, or a combination of one or more V-shapes. The above shapes of the meandering structures are just exemplary, and the invention is not limited thereto. Other features of the first antenna element 510 of FIG. 5 are similar to those of the first antenna element 110 of FIG. 1. Accordingly, the two embodiments can achieve similar levels of performance.

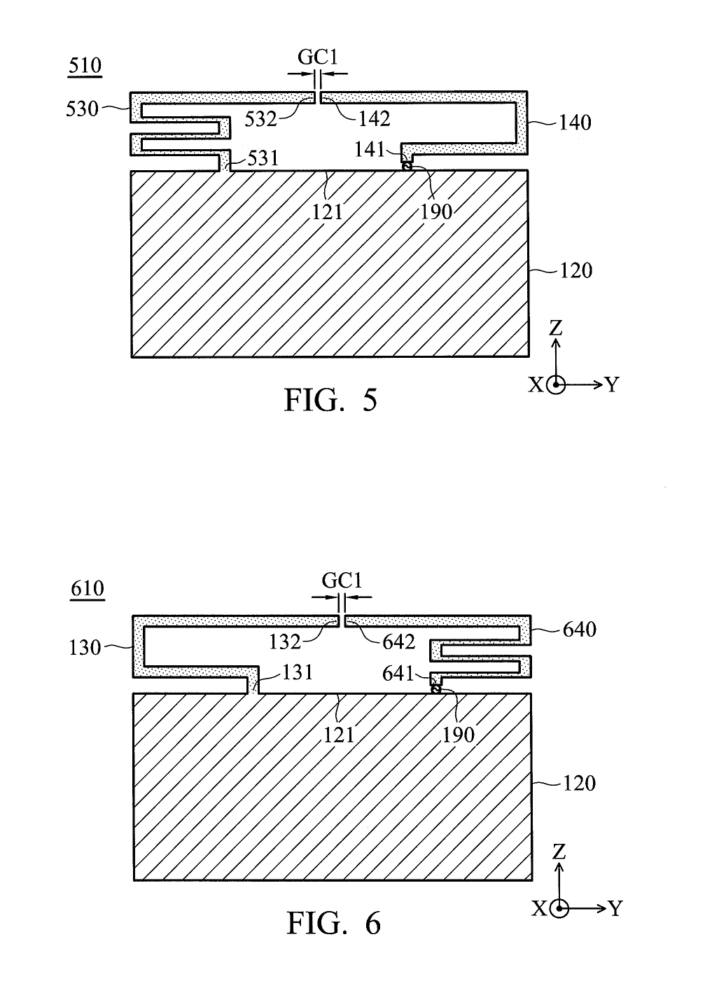

FIG. 6 shows a diagram of a first antenna element 610 according to an embodiment of the invention. In the embodiment of FIG. 6, a first feeding element 640 of the first antenna element 610 has a meandering structure. For example, the first feeding element 640 may substantially have a W-shape. Also, for example, the first feeding element 640 may substantially have a combination of one or more U-shapes, or a combination of one or more V-shapes. The above shapes of the meandering structures are just exemplary, and the invention is not limited thereto. Other features of the first antenna element 610 of FIG. 6 are similar to those of the first antenna element 110 of FIG. 1. Accordingly, the two embodiments can achieve similar levels of performance.

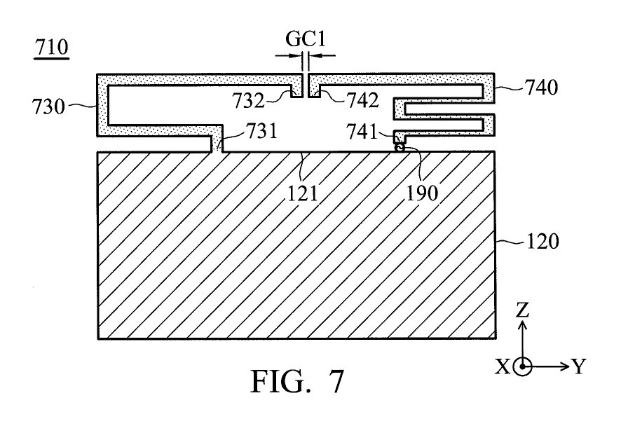

FIG. 7 shows a diagram of a first antenna element 710 according to an embodiment of the invention. In the embodiment of FIG. 7, a first feeding element 740 of the first antenna element 710 has a meandering structure. For example, the first feeding element 740 may substantially have a W-shape. Also, for example, the first feeding element 740 may substantially have a combination of one or more U-shapes, or a combination of one or more V-shapes. The above shapes of the meandering structures are just exemplary, and the invention is not limited thereto. On the other hand, the first feeding element 740 and a first grounding isolation element 730 of the first antenna element 710 each have a bent-end design. More particularly, an open end 742 of the first feeding element 740 is bent by about 90 degrees to extend toward the first edge 121 of the first ground plane 120, and an open end 732 of the first grounding isolation element 730 is also bent by about 90 degrees to extend toward the first edge 121 of the first ground plane 120. Other features of the first antenna element 710 of FIG. 7 are similar to those of the first antenna element 110 of FIG. 1. Accordingly, the two embodiments can achieve similar levels of performance.

Note that the above element parameters, element shapes, and frequency ranges are not limitations of the invention. An antenna engineer can adjust these settings or values according to different requirements. It is understood that the antenna system and the antenna element of the invention are not limited to the configurations of FIGS. 1-7. The invention may merely include any one or more features of any one or more embodiments of FIGS. 1-7. In other words, not all of the features shown in the figures should be implemented in the antenna system and the antenna element of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna system, comprising:
a first antenna element, comprising:
a first ground plane, having a first edge;
a first grounding isolation element, having a bending structure, wherein a grounding end of the first grounding isolation element is coupled to the first edge; and
a first feeding element, wherein a feeding end of the first feeding element is coupled to a first signal source, and an open end of the first feeding element is adjacent to an open end of the first grounding isolation element, such that a first resonant path is formed by the first feeding element and the first grounding isolation element;
wherein the first grounding isolation element is configured to reduce radiation of the first antenna element in a first direction.

2. The antenna system as claimed in claim 1, wherein a first coupling gap is formed between the open end of the first feeding element and the open end of the first grounding isolation element, and a width of the first coupling gap is at least 0.1 mm.

3. The antenna system as claimed in claim 1, wherein the first grounding isolation element substantially has a U-shape or a V-shape.

4. The antenna system as claimed in claim 1, wherein the first grounding isolation element comprises a first branch and a second branch, the first branch is adjacent to the open end of the first grounding isolation element, the second branch is adjacent to the grounding end of the first grounding isolation element, and the first branch and the second branch are both substantially parallel to the first edge.

5. The antenna system as claimed in claim 1, wherein the first grounding isolation element has a meandering structure.

6. The antenna system as claimed in claim 1, wherein the first feeding element substantially has a U-shape or a V-shape.

7. The antenna system as claimed in claim 1, wherein the first feeding element comprises a first branch and a second branch, the first branch is adjacent to the open end of the first feeding element, the second branch is adjacent to the feeding end of the first feeding element, and the first branch and the second branch are both substantially parallel to the first edge.

8. The antenna system as claimed in claim 1, wherein the first feeding element has a meandering structure.

9. The antenna system as claimed in claim 1, wherein a clearance region is substantially surrounded by the first feeding element, the first grounding isolation element, and the first edge.

10. The antenna system as claimed in claim 1, wherein the open end of the first feeding element and the open end of the first grounding isolation element are both bent to extend toward the first edge.

11. The antenna system as claimed in claim 1, wherein the first resonant path is excited to generate a low frequency band, the first feeding element is excited to generate a high frequency band, the low frequency band is substantially from 2200 MHz to 2800 MHz, and the high frequency band is substantially from 4920 MHz to 5850 MHz.

12. The antenna system as claimed in claim 1, further comprising:
a second antenna element, comprising:
a second ground plane, having a second edge;
a second grounding isolation element, having a bending structure, wherein a grounding end of the second grounding isolation element is coupled to the second edge; and
a second feeding element, wherein a feeding end of the second feeding element is coupled to a second signal source, and an open end of the second feeding element is adjacent to an open end of the second grounding isolation element, such that a second resonant path is formed by the second feeding element and the second grounding isolation element;
wherein the second grounding isolation element is configured to reduce radiation of the second antenna element in a second direction.

13. The antenna system as claimed in claim 12, wherein spacing between the first antenna element and the second antenna element is at least 1mm.

14. The antenna system as claimed in claim 12, wherein the second antenna element is substantially equivalent to a mirror image of the first antenna element, and the second grounding isolation element is disposed adjacent to the first grounding isolation element.

15. The antenna system as claimed in claim 12, wherein the first direction is opposite to the second direction, such that the first antenna element and the second antenna element do not tend to interfere with each other.

16. The antenna system as claimed in claim 12, wherein the first antenna element and the second antenna element substantially have the same operation frequency band.

17. The antenna system as claimed in claim 12, wherein a second coupling gap is formed between the open end of the second feeding element and the open end of the second grounding isolation element, and a width of the second coupling gap is at least 0.1 mm.

18. The antenna system as claimed in claim 12, wherein the second grounding isolation element substantially has a U-shape, a V-shape, or a meandering shape.

19. The antenna system as claimed in claim 12, wherein the second feeding element substantially has a U-shape, a V-shape, or a meandering shape.

20. The antenna system as claimed in claim 12, wherein a clearance region is substantially surrounded by the second feeding element, the second grounding isolation element, and the second edge.
